(19) United States
(12) Patent Application Publication
(10) Pub. No.: US 2001/0030094 A1
(43) Pub. Date: Oct. 18, 2001

(54) Components for brake systems, particularly for vehicles

(76) Inventor: Vittorio Pareti, Herrsching (DE)

Correspondence Address: Mr. Keith K. Nicolls; McCaleb, Lucas & Brugman, One South 376 Summit Avenue, Court C, Oakbrook Terrace, IL, 60181, US

(21) Appl. No.: 09/803,788

(22) Filed: Mar. 12, 2001

(30) Foreign Application Priority Data
Apr. 13, 2000 (IT) PD2000 A 000090

(51) Int. Cl. F16D 69/00

(52) U.S. Cl. 188/250 R; 188/218 XL

(57) ABSTRACT

The present invention concerns components for friction brakes, more particularly, vehicle braking components comprising a holding bracket characterized by plural carbon fiber layers.

This invention generally concerns components of friction brake assemblies, in particular, for vehicle brake assemblies; the sames particularly being suitable for disk and/or drum friction brake assemblies for automobiles, motorbikes, trains, airplanes, etc.

Brake systems used on vehicles typically comprise friction brakes such as disk brakes utilizing friction pads and drum brakes utilizing friction shoes. Brake pads readily available in the market feature many different shapes, depending upon manufacturer design, but typically comprise a metal supporting base (backing element) and a friction-generating material portion, dedicated to engage contact with the internal rotating surface of a drum or disk connected to the spinning wheels of the vehicles. It is known that, during vehicle braking, kinetic energy of the vehicle is fully or mostly converted to heat. Braking friction pads and friction shoes are consequently subjected to significant temperature rise that in heavy duty or critical conditions may lead to a significant reduction in mechanical operation and efficiency. Additionally, any vibration generated between disks and pads or between drums and friction shoes, respectively, is, in general, rigidly propagated or transmitted.

An important object of this invention is to provide a brake friction pad structure that minimizes heat transmission between brake pads and related piston or caliper assemblies.

Another object hereof is to provide a brake friction pad and/or a friction shoe which is less reactive to temperature increase and more resistant in critical working conditions.

Still another, but not least, object is to provide a brake pad that features vibration damping/absorption.

The foregoing main objects and goals as well as additional objectives will appear more clearly from the description which follows relating to novel reinforcing pads for brake assemblies, particularly used for vehicles wherein the reinforcing pads comprise several layers of carbon fiber.

Additional features and advantages of the present invention will appear more clearly by description of a preferred embodiment, shown in the attached drawings wherein:

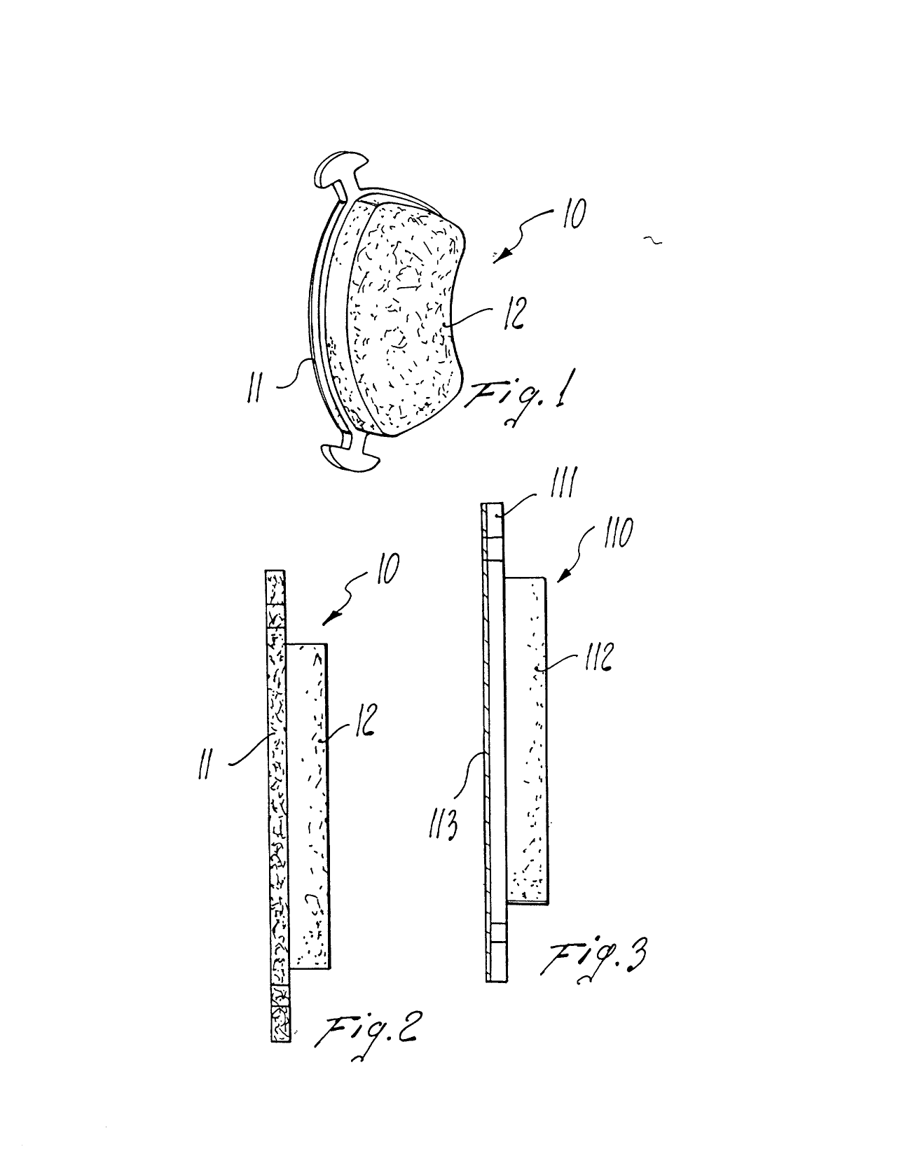

FIG. 1 shows a prospective view of a friction pad assembly for disk brakes according to the present invention;

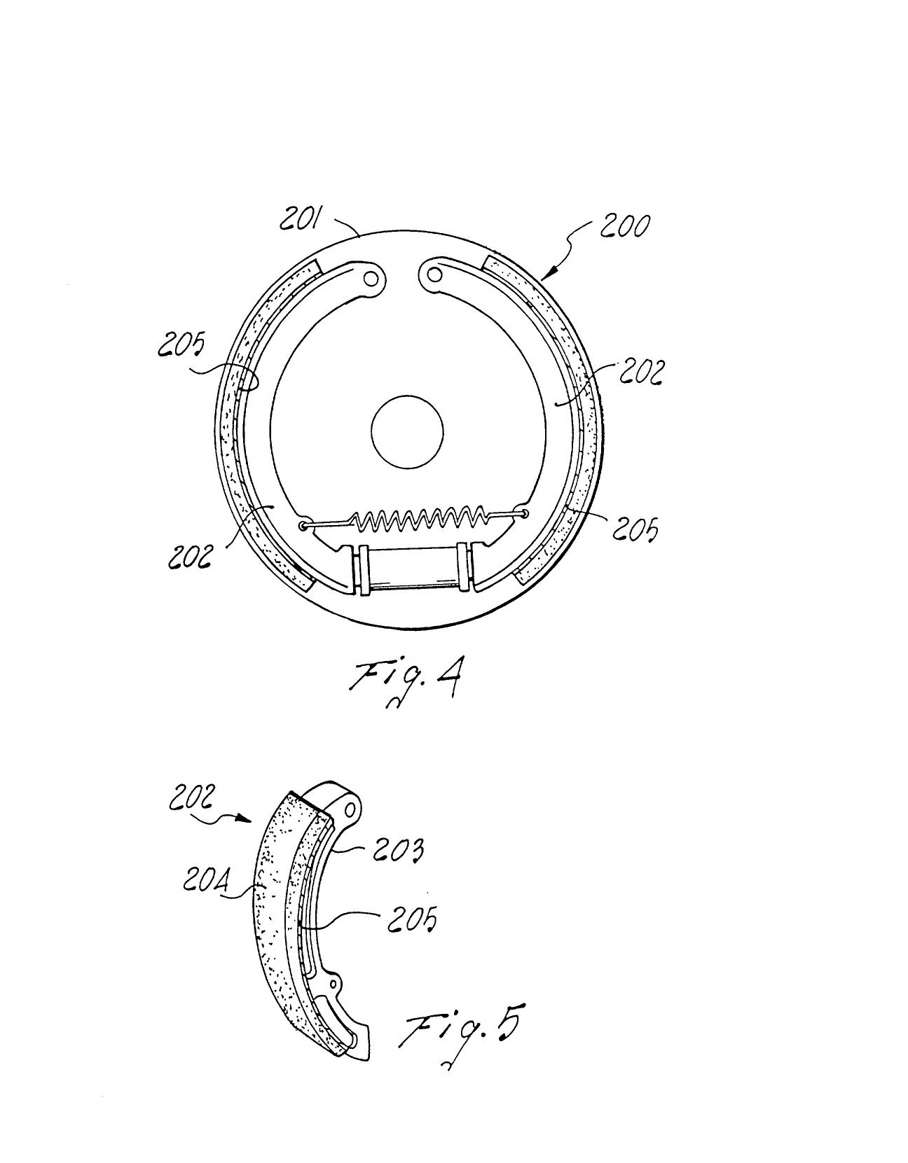

FIGS. 2 and 3, respectively, show side elevations of first and second different embodiments of the pad assembly shown in FIG. 1;

FIG. 4 shows a drum-brake structure using friction shoes according to the present invention; and

FIG. 5 shows, in a prospective view, a single friction shoe of the brake structure shown in FIG. 4.

With particular reference to FIGS. 1 and 2, one component of a brake assembly, according to the present invention useful with disk brakes is indicated at number 10. The brake pad assembly 10 comprises a backing plate element 11 and a molded friction-generating braking layer (element) 12. The backing plate element 11 is obtained by over laying and gluing or otherwise fixing a plurality of carbon fiber layers; each layer comprising a fabric of carbon fiber wherein each individual strand comprises at least one carbon fiber as well as one wire (metal yarn). The carbon fabric layers may be glued together by a hot or cold impregnation of epoxy resin. Alternatively, layers 12 can be manufactured and glued together by a known press-injection process.

Advantageously, a brake friction-generating layer 12 is a sintered element comprising a percentage of carbon fiber ranging between 4% and 15% mixed with other commonly used friction materials.

Advantageously, a disk brake rotor can be coated with one layer of carbon fiber impregnated with epoxy resin. Said epoxy can be used as a bonding means between the carbon coating layer and the metal. Alternatively, double sided adhesive can be used as adhesive means.

FIG. 3 shows a second embodiment of the brake pad assembly 10 which comprises a pad supporting element 111 for a sintered friction-generating element 112. In such case, the backing pad 111 is manufactured of metal and the surface dedicated to contact with a caliper is coated with a carbon fiber layer that, in this case, materializes in a reinforcement pad assembly 113 of multi-layer fabric wherein each strand comprises a plurality of yarns featuring at least one element of carbon fiber and one element of wire (steel). The layer 113 can be hot or cold glued to the backing pad element 111, or alternatively assembled via press-injection. As another alternative, a layer of double-stick adhesive tape can be used to glue the two elements 110 and 113 together. The reinforcing pad 113 or the layers of the backing pad element 111 can be manufactured with a weldable steel wire. Also, the sintered friction-generating braking element 112 contains a percentage of carbon fiber powder ranging between 4% and 15% The fabric is usually applied via press injection at a temperature ranging between 80 and 140 Celsius degrees.

FIG. 4 shows a drum friction brake assembly, indicated at number 200, comprising a braking component, that in this case, materializes in one or more friction shoes 202. Brake assembly 200 as shown here is formed with two friction shoes 202 located internally of cylindrical drum 201 coupled to a rotating wheel (not shown). Each friction shoe includes a curved, backing support element 203 made of metal, such as steel, carrying on its surface facing the drum 201, a friction-generating element 204 (see FIG. 5). Like the brake elements 12 and 112, previously described, the friction-generating element 204 preferably is a sintered material manufactured with a percentage of carbon fiber powder ranging from 4% to 15% mixed with other material commonly used in the manufacture of friction materials for brake pads and shoes. Element 204 is made by overlapping and fixing a plurality of carbon fiber layers materialized in a multi-layer fabric, each individual strand of which includes at least one carbon fiber as well as one wire. Fixing techniques to glue together the layers of the reinforcing element 204 can be the very same used for the reinforcing element 11 of the brake friction pad assembly 10. Between the backing support 203 and the friction-generating element 204, a layer of carbon fiber reinforcing element 205 can be interposed. Advantageously, the inner drum surface dedicated to cooperate with the brake friction-generating element can be coated with a layer of carbon fiber fabric impregnated with epoxy resin that can work as a bonding means with metal. Alternatively, double sided adhesive tape can be used to glue the drum surface to said friction material.

From the above description, it appears clear how the present invention obtains the main objects and goals. In particular, by manufacturing in carbon fiber the reinforcing element for a brake friction pad assembly, it is possible to obtain brake pads and friction shoes with very high thermal resistance. The use of a layer of fabric partially manufactured with carbon fiber serves to isolate even a normal brake pad from an associated piston/caliper assembly. Furthermore, the manufacture of sintered friction-generating material using carbon fiber powder optimizes the performance of the brake pad assembly and the friction shoes at high temperatures. Brake pads or friction shoes using a reinforcing element and a sintered friction element like the ones described herein can be used in virtually any kind of vehicle or motorbike, as well as in airplanes, trains and many other vehicles.

The present invention can be modified in different embodiments all to be considered part of the present invention and technical details are replaceable with other equivalent ones additionally materials and dimensions which may vary according to the application as long as they are compatible with the use, without departing from the spirit and scope of this invention which is unlimited by the foregoing except as may appear in the following appended claims;

I claim:

1. A brake component for vehicle friction brake assemblies comprising a backing plate reinforcing means for a brake friction pad assembly wherein said reinforcing means is comprised of several carbon layers.

2. A brake component as defined in claim 1, wherein said carbon layers comprise carbon fiber fabric.

3. A brake component as defined in claim 2, wherein each layer of said carbon fiber fabric comprises multiple strands each one of which comprises a plurality of yarns of which at least one is carbon fiber and at lease one is metal wire.

4. A brake component as defined in claim 3, wherein said stands comprise a plurality of weldable metal wires.

5. A brake component defined in claim 1 wherein each of said carbon layers has a thickness ranging between 0.4 and 2 millimeters.

6. A brake component defined in claim 1, wherein a friction-generating element of said brake friction pad assembly is a sintered assembly comprising carbon powder in a percentage ranging between 4% and 15%.

7. A brake pad as defined in one or more of claims 1-6 wherein said reinforcing means is comprised of metal; the outer surface of which is coated with at least one layer of carbon for braking engagement.

8. A brake shoe component as defined in claim 6 wherein at least one carbon layer is interposed between said reinforcing means and said friction-generating element.

9. A disk rotor for a brake friction assembly comprising a layer of carbon fiber coating outer surfaces of said rotor for at least that portion cooperating with a friction pad assembly.

10. A drum rotor for a brake friction assembly comprising a layer of carbon fiber coating inner surfaces of said drum rotor for at least that portion thereof cooperating with friction brake shoes.
